(19) United States
(12) Patent Application Publication
(10) Pub. No.: US 2004/0054827 A1
(43) Pub. Date: Mar. 18, 2004

(54) Large volume storage device with a memory card adapting interface

(76) Inventors: Wen-Tsung Liu, HsinDian City (TW); Hsiang-An Hsieh, HsinDian City (TW)

Correspondence Address: TROXELL LAW OFFICE PLLC, SUITE 1404, 5205 LEESBURG PIKE, FALLS CHURCH, VA, 22041, US

(21) Appl. No.: 10/244,022

(22) Filed: Sep. 16, 2002

(51) Int. Cl. G06F 13/12

(52) U.S. Cl. 710/74

(57) ABSTRACT

This invention relates to a large volume storage device with a memory card-adapting interface to transfer data from/to digital electronic devices with a second socket. The said storage device comprises of a circuit board, a power supply unit connected to the circuit board to deliver power to the said storage device, a storage media connected to the circuit board through a transfer interface, and an simulated card adapting interface that has a standard plug structure on one end to connect the said large volume storage device to the said socket and a interface cable on the other end, which is connected to the circuit board. With the help of the operating interface (display, browse, or delete) of the said digital electronic device, the standard instructions and control commands of the simulated card can be translated into instructions and control commands that can be identified by the storage device through the simulated card-adapting interface, in order to transfer data from the card to the storage device.

### BACKGROUND OF THE INVENTION

1. Field of Invention

This invention relates to a large volume storage device, particularly relates to a large volume storage device with a memory card-adapting interface.

2. Description of the Background Art

As IT products evolves towards smaller size, small flash memory cards (hereunder is referred as small memory cards) are becoming more popular in the market, in particular Compact Flash Card (CF), Memory Stick Card (MS), and Secure Digital Card (SD). All above memory cards utilize silicon chips as the storage media and are connected to IT products or digital electronic devices through specific electric interfaces to store digital information. In addition, those small memory cards are small, light, power saving, shock tolerant, large in volume, and reliable, etc. they have been widely used in various digital IT devices, in particular portable electronic devices, such as Digital Still Cameras (DSCs), Personal Digital Assistants (PDAs), Digital Music Players (DMPs), Digital Video Cameras (DVCs), and MP3 players.

However, due to the limitation in silicon chip, size, and power consumption, existing small memory cards still can't exceed some traditional storage media in volume, such as hard disks and CD-ROM drives. For example, the maximum volumes of SD Cards and MS Cards are about 256 MB and 128 MB respectively. If they are used in high density DSC products, which support 6 million or more pixels and each photo consumes 3 MB or more storage space, a SD Card can only store 40-70 photos and can't meet the requirements of the users.

To solve the insufficient volume of above small memory cards, users may purchase multi cards as supplement. However, because that the average ratio of capacity/cost of small memory cards is still lower than that of some traditional storage media, additional cards will burden users with more investment.

Hence there are some manufacturers combine a hard disk with a control circuit board containing a socket for a small memory card as the backup device for the small memory card, i.e., when a small memory card is used up, the user may take it out from the digital electronic device and insert it in the “Small Memory Card Backup Device” (usually a hard disk drive) to transfer or back up the data in the small memory card to the device. Then the user may format the small memory card again or delete original data in it to implement reuse.

Though the “Small Memory Card Backup Device” described above solved the problem of insufficient volume of small memory cards and eliminated the need to purchase multi cards, the operation procedures for it is inconvenient, complex, and are often unable to ensure the result of data transfer or backup. In case any problem occurs in data transfer or backup, the data stored in the small memory cards will be lost, which may bring the users great trouble.

### SUMMARY OF THE INVENTION

In consideration of above problems, the inventor invents a large volume storage device with a memory card-adapting interface.

The main purpose of this invention is to provide a large volume storage device with a memory card-adapting interface to connect a digital electronic device. Through the operation interface and functions of the digital electronic device, the digital information acquired can be stored or moved to the said large volume storage device, or the information stored in the large volume storage device can be transferred to the digital electronic device. Such an invention can significantly decrease the cost of large volume storage media, making them more expandable, cheaper, and more convenient.

The “simulated card adapting interface” in this invention is similar to standard small memory cards in electric circuit, structure, and size. It connects to the large volume storage device through an interface signal cable. Thus the user can connect a digital electronic device to the socket for small memory card to expand the storage capacity of the digital electronic device. The installation and operation is more convenient and simpler than those in traditional “Small Memory Card Backup Devices”.

Another purpose of this invention is to implement direct data backup and transfer to the small memory card or data exchange with a PC through adding a standard memory card socket or an interface cable connected to a PC together with a GUI (in particular for stand alone operation cases) on the large volume storage device. The technologies used in this invention and the features of it are further detailed in the following illustrations and descriptions.

### BRIEF DESCRIPTION OF THE DRAWINGS

FIG. 1 is a block diagram of a preferred embodiment implemented according to this invention.

FIG. 2 is a block diagram of another preferred embodiment implemented according to this invention.

FIG. 3A is the circuit diagram of this invention when a SD card is inserted in it.

FIG. 3B is the circuit diagram of this invention when a MS card is inserted in it.

FIG. 4 is the functional block diagram of the connection between a USB interface and a CF card used in this invention.

FIG. 5 is the circuit diagram of the hardware in FIG. 4.

FIG. 6 is the functional block diagram of the connection between a CF card and a storage media through a USB interface cable in this invention.

FIG. 7 is the circuit diagram of the hardware in FIG. 6.

### INSTRUCTION TO SYMBOLS

Instruction to Symbols

| | |
|---|---|
| Large Volume Storage Device | 10 |
| Storage Media | 12 |
| User Interface | 14 |
| First Socket | 18 |
| Power Supply | 16 |
| Micro Controller | 20 |
| Interface Signal Cable | 24 |
| Power Conversion Circuit | 26 |
| Circuit Board | 30 |
| Connector | 36 and 38 |
| SD Card | 40 |
| MS Card | 50 |
| CF Card | 60 |
| CF Controller | 62 |
| USB Controller | 64 |
| USB Interface Connector | 66 |
| Voltage Boosting Circuit | 68 |
| Simulated Card Adapting Interface | 90 |
| Digital Electronic Device | 100 |
| Second Socket | 102 |

### DETAILED DESCRIPTION OF THE DRAWINGS

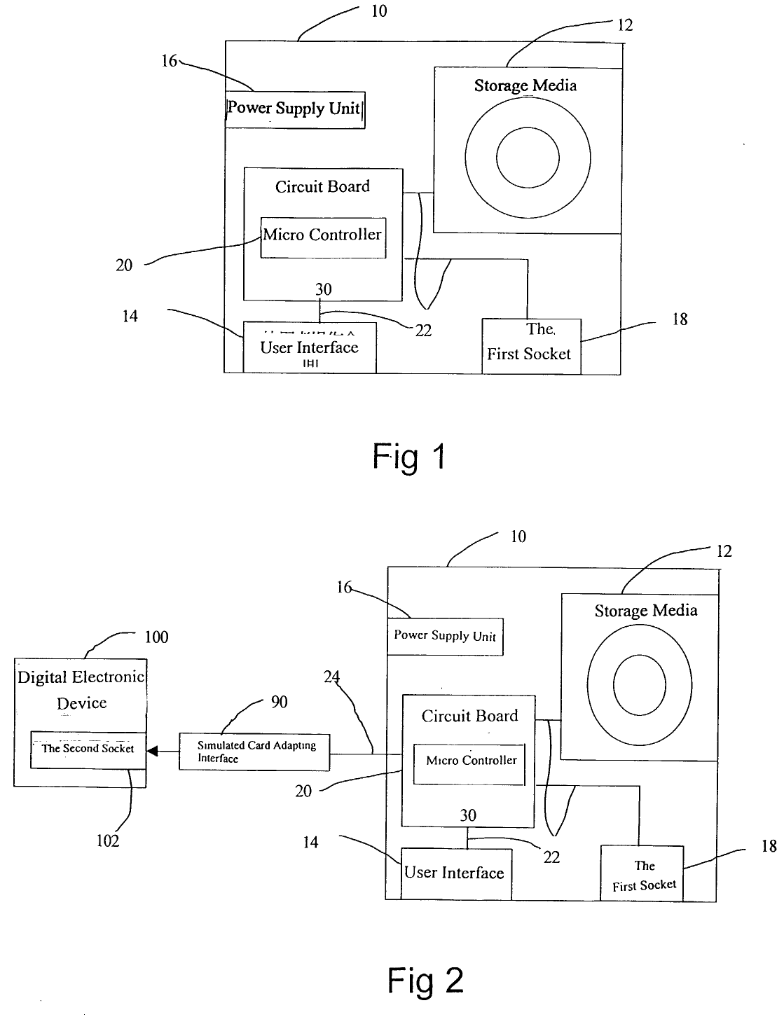

Please see FIG. 1, a preferred embodiment of this invention. The large volume storage device in FIG. 1 comprises of:

a circuit board 30;

a power supply unit 16 connected to the circuit board 30 with a embedded or external power supply and one or more batteries;

a storage media 12 connected to the circuit board 30 through a transfer interface 22, and

the first socket 18 with a shared container to hold and access multi types of memory cards (CF, MS, or SD card, not shown) at different times. The first socket 18 is connected to the circuit board 30 through the interface 22.

When any of above memory cards is inserted into the first socket 18, the circuit board 30 controls the conversion of the instructions and the control program of the memory card inserted to instructions and control program that can be identified by the storage media 12. Then information can be transferred or backed up on the storage media 12.

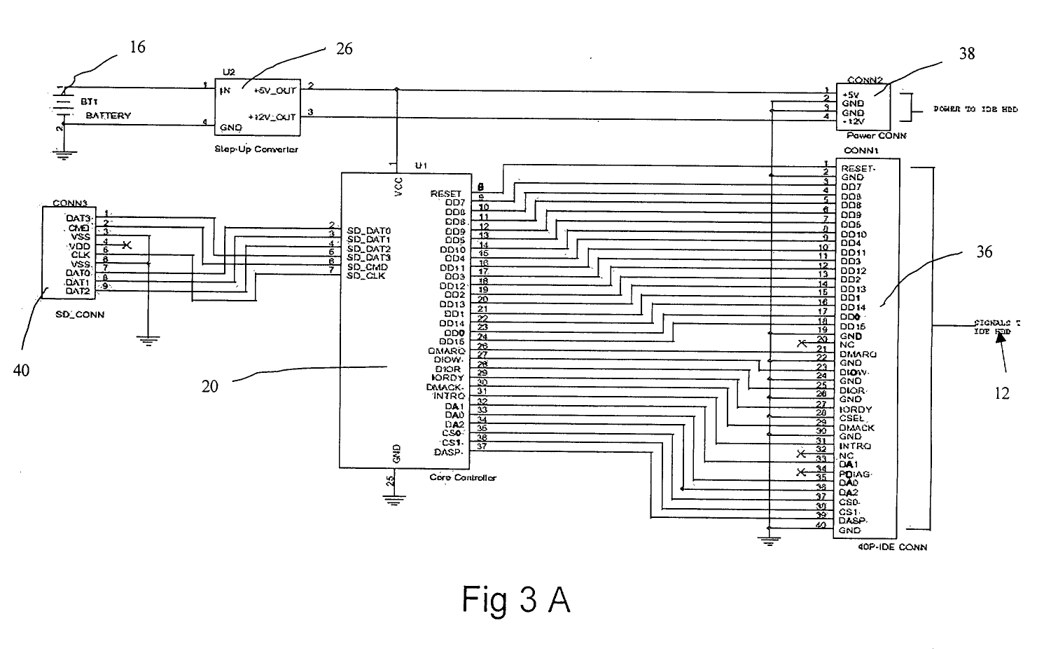

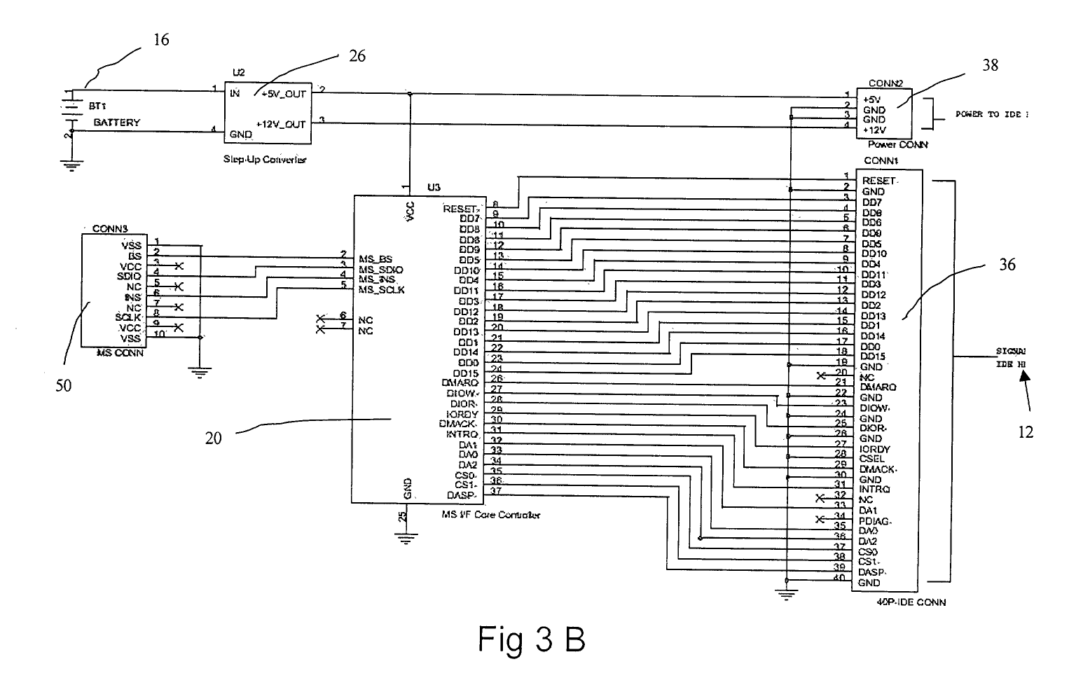

Moreover, the circuit board 30 has a micro controller 20 and a power conversion circuit (as shown in FIG. 3A and FIG. 3B). The power conversion circuit can transform power into internal voltage of the micro controller 20 and the storage media 12 with over-current protection and voltage regulation functions. The micro controller 20 performs detection, switching, and control.

The storage media 12 described above may be a HDD, CD-RW, DVD-RW, DVD RAM, MO, ZIP, or embedded Flash Memory card. The transfer interface in the large volume storage device 10 supports IDE/ATA, IDE/ATAPI, USB, or IEEE 1394 interface.

To control the transfer or backup of information in the memory card to the storage media 12, a user operation interface 14 may be provided for the large volume storage device 10 to facilitate the user to master and control the processing (e.g., store, browse, or delete) of information between the memory card and the storage media 12. Alternatively, an interface cable (not shown) can be used to connect the large volume storage device 10 to a PC to support the data exchange between the device and the PC.

Please see FIG. 2, another preferred embodiment of this invention. The “large volume storage device with a memory card-adapting interface” 10 in this invention can support digital electronic devices 100 with the second sockets 102 to carry out data transfer or backup. Which comprises:

a circuit board 30;

a power supply unit 16 connected to the circuit board 30 with a embedded or external power supply (AC) and one or more batteries;

a storage media 12 connected to the circuit board 30 through a transfer interface 22, and

an simulated card adapting interface 90. The simulated card-adapting interface 90 may be connected to a standard memory card on one end, which can be inserted into the second socket 102 directly. And the simulated card-adapting interface is connected to the circuit board 30 on the other end through an interface signal cable 24. The memory card may be a CF, MS, or SD card.

Utilizing the operation interface (display, browse, or delete) provided by the digital electronic device 100 connected to this invention, the invention can transform the standard instructions and the control program for the memory card into instruction and control program that can be identified by the storage media 12 to transfer or back up information in the storage media 12. This invention can also provide a user interface 14 for the large volume storage media 12 to facilitate the users to master and control the data transfer or backup between the digital electronic device 100 and the storage media 12.

Furthermore, thin invention can also employ the first socket 18 and an interface cable (not shown) to connect to a PC. In this way, this invention can be an independent storage device. The first socket 18 has a container to hold various memory cards at different times, and it can be connected to the storage media 12 through the transfer interface 22 via the circuit board 30 to perform data transfer and backup, or it can exchange data with a PC through an interface cable connected to the PC.

The hardware circuit components in this invention are further detailed as follows. Please see FIG. 3A and FIG. 3B, circuit diagrams of this invention when a SD or a MS card is inserted. In the simulated card-adapting interface 90, the memory card may be a SD card or a MS card. The simulated card-adapting interface has embedded power supply unit 16, a micro controller 20, a power conversion circuit 26, and a connector 36 or 38 to connect the specific transfer interface in the storage media 12 (a IDE interface is shown in the figure). The power conversion circuit 26 is equipped with one or more batteries to convert the power to the internal +5V and +12V used internally in the micro controller 20 and the storage media 12. If the batteries are used up, the user can change them with new ones or connect the device directly to AC power supply. The power conversion circuit 26 also delivers over-current protection and voltage regulation functions. The micro controller 20 can execute key functions including detection, switching, and control. The connector 36 or 38 is connected to the storage media 12 or the power supply unit 16. The interface signal cable 24 provided with the simulated card-adapting interface 90 can be a USB IEEE1394 cable or a specific cable for the memory card inserted in this invention.

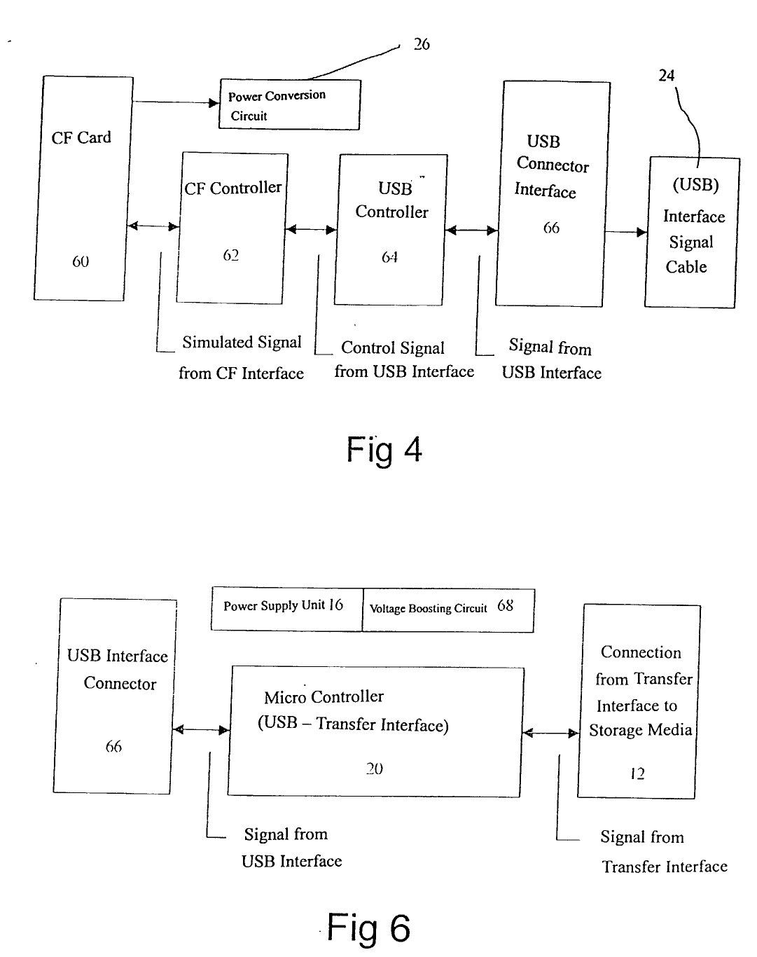

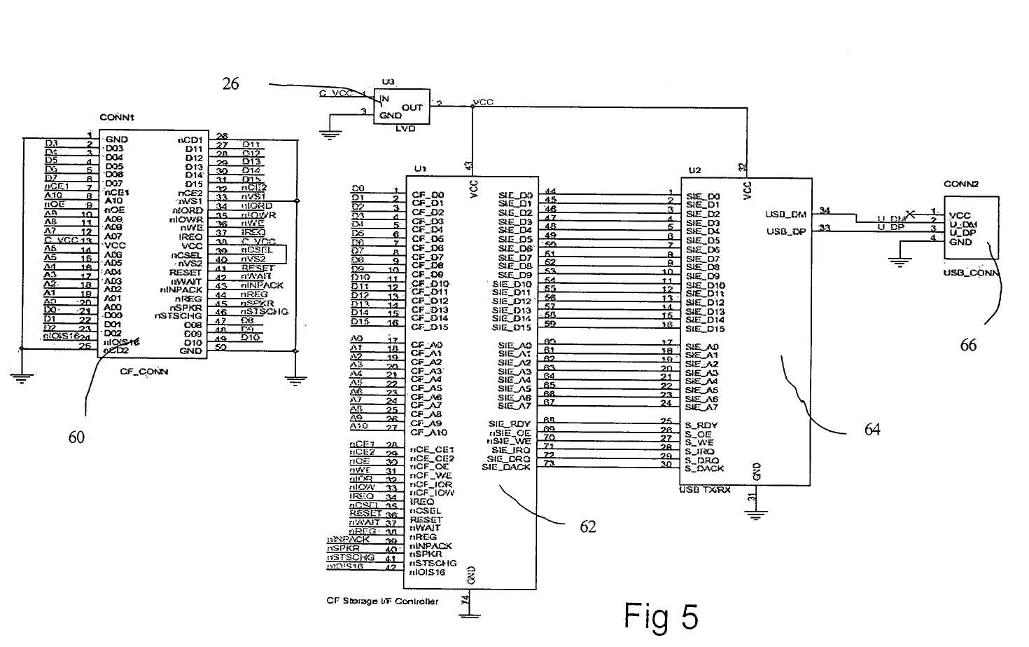

In consideration that the application of CF Card is complex (50 PINs), it is detailed here. Please see FIG. 4 and FIG. 5, a block diagram and a hardware circuit diagram of the connection between a USB interface cable 24 and a CF Card 60. Besides the power conversion circuit 26, the CF Card 60 also involves a CF controller 62, a USB controller 64, and a USB interface connector 66. It is connected to the storage media 12 through a USB interface signal cable 24.

In other words, the CF Card 60 and the USB interface signal cable 24 constitute a wired simulated card-adapting interface 90, which is inserted into the second socket 102 (for CF Card) on the digital electronic device 100. Then, the power is converted into the internal voltage for the CF card through the power conversion circuit 26. At the same time, the CF card controller 62 simulates a standard CF card 60 interface and relevant communication protocol to accept signals/instructions sent by the digital electronic device 100 via the interface of CF Card 60 and then convert the instructions into standard USB interface communication protocol and instructions and send them to the USB interface connector 66 through the USB controller 64. Next, the USB interface connector 66 access the instructions through the interface signal cable 24 and send the result back to the USB controller 64 through the USB interface. The CF controller 62 continuously monitors the USB interface (communication) signals according to the communication protocol for standard USB interface. When it receives the result, it converts the result into the communication protocol for standard CF Cards 60, and sends the data to the digital electronic device 100, which has the instructions sent from the operation interface. And then the digital electronic device can “know” the information and perform storage/backup or other actions.

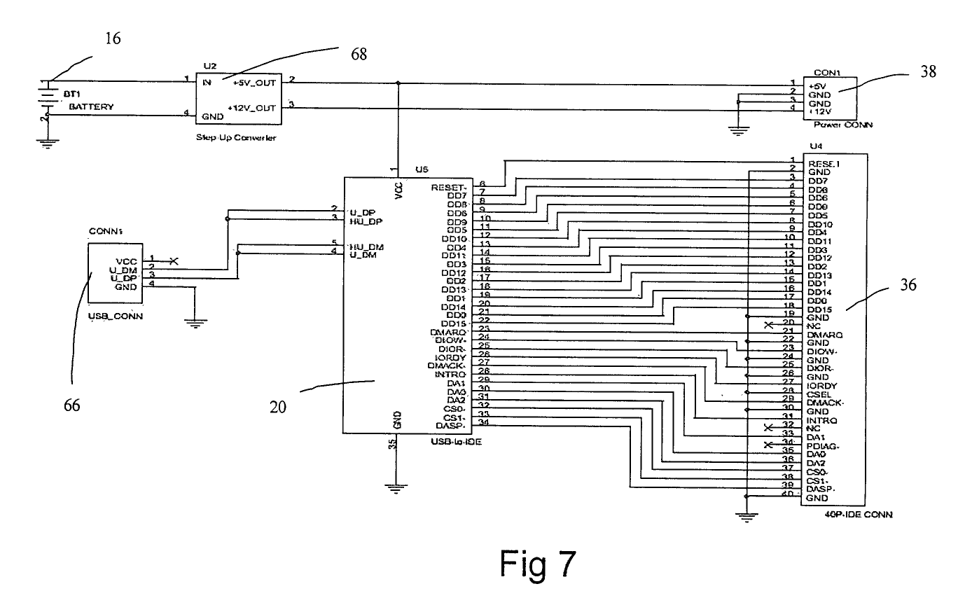

Please see FIG. 6 and FIG. 7, a block diagram and a circuit diagram of the connection between the CF card 60 and the storage media 12 through the USB interface signal cable 24. The embedded power supply unit 16 delivers power to the USB—IDE micro controller 20 and the IDE storage media 12 through a voltage boosting circuit 68. The USB interface connector 66 is connected to the micro controller 20 on the circuit board 30, which converts standard instructions and communication protocol for USB interface into those for the IDE storage media 12 through the USB interface signal cable 24 and exchange the information related with the access result through the USB interface of the “Simulated CF Card Adapting Interface” to implement the simulation of a CF Card 60 on the digital electronic device 100.

It should be noted that the application of above storage media 12 and transfer interface 22 is similar to that in the first preferred embodiment.

In conclusion, the “large volume storage device with a memory card adapting interface” in this invention delivers at least the following benefits:

1. Direct one-way or two-way data transfer between the device and a large volume storage media or the device and a digital electronic device through the “simulated memory card adapting interface” with the operation interface provided by the digital electronic device without any additional operation interface. Such a device in this invention can decrease the cost, expand the storage capacity, and simply the operation.

2. Utilization of a cheap simulated standard small memory card as the electric interface of the “simulated card” together with a interface signal cable to facilitate the user to expand the storage capacity of any digital electronic device through insertion of the device in this invention to the second socket in the digital electronic device. The installation and operation of this invention is very convenient and direct, eliminating complex procedures to be taken in application of traditional small memory card products.

3. Addition of a standard socket (the first socket) to the invention to connect to a PC through a cable and utilization of a user interface to control the invention (i.e., serving as a independent large volume storage device).

What is claimed is:

1. A large volume storage device comprises:
a circuit board;
a power supply unit connected to the circuit board with a embedded or external power supply and one or more batteries;
a storage media connected to the circuit board through a transfer interface, and
the first socket with a shared container to hold and access multi types of memory cards (CF, MS, or SD card) at different times;
when any of above memory card is inserted into the first socket, the circuit board controls the conversion of the instructions and the control program of the memory card inserted to instructions and control program that can be identified by the storage media. Then information can be transferred or backed up on the storage media.

2. The large volume storage device as in claim 1, wherein the circuit board has a micro controller and a power conversion circuit; the power conversion circuit can transform power into internal voltage of the micro controller and the storage media with over-current protection and voltage regulation functions. The micro controller performs detection, switching, and control.

3. The large volume storage device as in claim 1, wherein the storage media can be a HDD, an optical disk (CD, DVD, or MO), a diskette (Zip), or a embedded Flash Memory.

4. The large volume storage device as in claim 1, wherein the device may have a user operation interface to facilitate the user to master and control the processing (e.g., store, browse, or delete) of information between the memory card and the storage media.

5. The large volume storage device as in claim 1, wherein the embedded power supply unit involves one or more batteries, and the external power supply unit usually is a common AC power supply.

6. The large volume storage device as in claim 1, wherein the memory card can be a CF, MS, or SD card.

7. The large volume storage device as in claim 1, wherein the interface may be an IDE/ATA, IDE/ATAPI, USB, or IEEE 1394 interface.

8. A large volume storage device with a memory card adapting interface to transfer or backup data from a digital electronic device with a second socket, which comprises:
a circuit board;
a power supply unit connected to the circuit board with a embedded or external power supply and one or more batteries;
a storage media connected to the circuit board through a transfer interface, and
a simulated memory card adapting interface forming a standard memory card structure at one end to be connected to the second socket and a interface signal cable at the other end to connect to the circuit board;
with the help of the operating interface (display, browse, or delete) of the said digital electronic device, the standard instructions and control commands of the simulated card can be translated into instructions and control commands that can be identified by the storage device through the simulated card-adapting interface, in order to transfer data from the card to the storage device.

9. The large volume storage device with a memory card adapting interface as in claim 8, wherein the circuit board has a micro controller and a power conversion circuit; the power conversion circuit can transform power into internal voltage of the micro controller and the storage media with over-current protection and voltage regulation functions. The micro controller performs detection, switching, and control.

10. The large volume storage device with a memory card adapting interface as in claim 8, wherein the storage media can be a HDD, an optical disk (CD, DVD, or MO), a diskette (Zip), or a embedded Flash Memory.

11. The large volume storage device with a memory card adapting interface as in claim 8, wherein the memory card can be a CF, MS, or SD card.

12. The large volume storage device with a memory card adapting interface as in claim 8, wherein the embedded power supply unit involves one or more batteries, and the external power supply unit usually is a common AC power supply.

13. The large volume storage device with a memory card adapting interface as in claim 8, wherein the interface may be an IDE/ATA, IDE/ATAPI, USB, or IEEE 1394 interface.

14. The large volume storage device with a memory card adapting interface as in claim 8, wherein the device may have a user operation interface to facilitate the user to master and control the processing (e.g., store, browse, or delete) of information between the digital electronic device and the storage device.

15. The large volume storage device with a memory card adapting interface as in claim 8, wherein the device has the first socket, which has a container to hold/access to multi types of memory cards and implement data transfer and backup with the storage media through the transfer interface.

16. The large volume storage device with a memory card adapting interface as in claim 8, wherein the interface signal cable may be a USB, IEEE, or specific signal cable for the memory card interface used in this invention.
